(19) United States
(12) Patent Application Publication
(10) Pub. No.: US 2009/0037481 A1
(43) Pub. Date: Feb. 5, 2009

(54) CHANGE-BASED DISCOVERY SCHEDULING

(76) Inventor: RONALD B. BAKER, Sanford, NC (US)

Correspondence Address: DILLON & YUDELL LLP, 8911 N. CAPITAL OF TEXAS HWY., SUITE 2110, AUSTIN, TX, 78759, US

(21) Appl. No.: 11/832,320

(22) Filed: Aug. 1, 2007

(51) Int. Cl. G06F 12/00

(52) U.S. Cl. 707/200; 707/E17.005

(57) ABSTRACT

A method, system and computer-readable medium for an enhanced service management program are disclosed. The program scans configuration items at the beginning and end of a request for change. Periodic scans are performed in between requests for change. In one embodiment, the service management program scans one or more configuration items associated with a request for change at the time of assessment of the request for change. The service management program scans the same configuration items associated with said request for change at the time of verification of the request for change. The service management program periodically scans one or more configuration items between requests for change based on a discovery profile for each of said one or more configuration items. The service management program records configuration information of the configuration items discovered from each of the scans into a configuration management database.

### BACKGROUND OF THE INVENTION

The present invention relates in general to the field of computers and information technology (IT), and in particular to information systems management.

The central data control point for IT service management solutions is a configuration management database (CMDB), such as the CMDB defined by the best practices documents of the Information Technology Infrastructure Library (ITIL®). As a result, it is critical that the information in a CMDB be accurate and timely.

A CMDB is a repository of information related to all the components of an information system. Each component of an information system is known as a configuration item (CI). A CI is an IT asset or a combination of IT assets that may depend on and have relationships with other IT processes. The CMDB records configuration items and details about the important attributes and relationships between CIs.

A key success factor in implementing a CMDB is the ability to automatically discover information about CIs and track changes as they happen. The typical approach for CI discovery is to scan each CI on a periodic basis. The periodic scan is usually configurable for segments of the network. This periodic scan tends to be resource and network intensive, pulling large amounts of data back to the central server, where there are additional load and concurrency issues to update the CMDB. As the number of resources, relationships, and changes increase, this periodic scanning approach becomes harder and harder to scale. Additionally, periodic scanning does not account for changes to CIs between scan intervals, reducing the accuracy of the information about the CIs in the CMDB.

### BRIEF SUMMARY OF THE INVENTION

The present invention provides a method, system and computer program product for an enhanced service management program of a data processing system. The enhanced service management program scans configuration items at the beginning and end of the servicing of a request for change. These scans give an accurate “snapshot” of the state of the configuration items before and after authorized changes are made pursuant to a request for change. Unauthorized changes are detected by periodic scans in the intervals between the servicing of requests for change. The enhanced service management program provides a more accurate and timely configuration management database. In addition periodic scans are often reduced, thereby improving overall system performance.

In one embodiment, the service management program scans one or more configuration items associated with a request for change, at the time of assessment of the request for change. The service management program scans the same configuration items associated with said request for change at the time of verification of the request for change. The service management program periodically scans one or more configuration items between requests for change based on a discovery profile for each of said one or more configuration items. The service management program records configuration information of the configuration items discovered from each of the scans into a configuration management database.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary data processing system in which the present invention may be implemented;

FIG. 2 is a diagram depicting an exemplary configuration management database, several configuration items and attributes of the configuration items;

FIG. 3 is a flowchart of an exemplary method for providing an enhanced service management program; and

FIG. 4 is a timeline depicting an example of the scheduling of discovery scans in accordance with one or more embodiments of the present invention.

### DETAILED DESCRIPTION OF THE INVENTION

An illustrative embodiment of the present invention is directed to an enhanced service management program of a data processing system. The present invention can take the form of an entirely hardware embodiment, an entirely software embodiment or an embodiment containing both hardware and software elements. In an illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk—read only memory (CD-ROM), compact disk—read/write (CD-R/W) and Digital Versatile Disk (DVD).

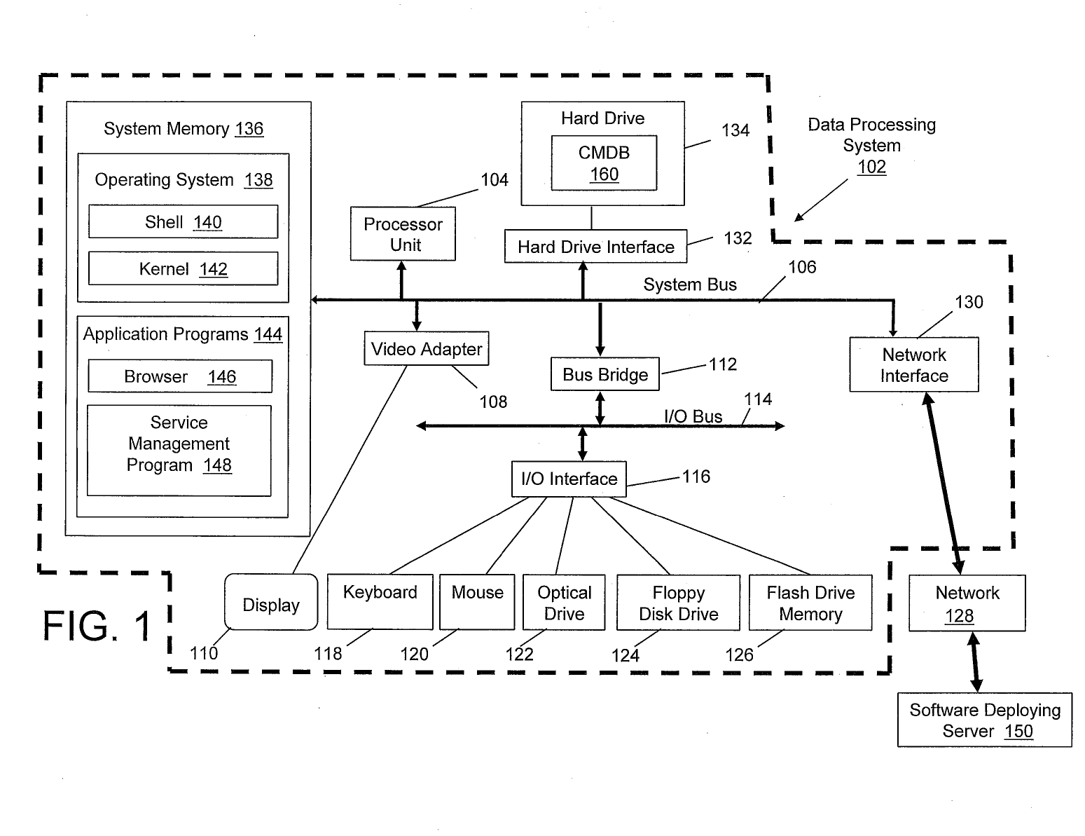

Referring now to the drawings, wherein like numbers denote like parts throughout the several views, FIG. 1 shows a block diagram of a data processing system suitable for storing and/or executing program code in accordance with one or more embodiments of the present invention. The hardware elements depicted in data processing system 102 are not intended to be exhaustive, but rather are representative of one embodiment of the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to PO bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

A hard drive interface 132 is also coupled to system bus 106. Hard drive interface 132 interfaces with hard drive 134. In an illustrative embodiment, hard drive 134 populates a system memory 136, which is also coupled to system bus 106. Data that populates system memory 136 includes an operating system (OS) 138 of data processing system 102, application programs 144 (e.g., service management program 148) and configuration management database (CMDB) 160.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., data processing system 102) to send and receive network messages to the Internet using HyperText Transfer Protocol (HTTP) messaging, thus enabling communication with software deploying server 150.

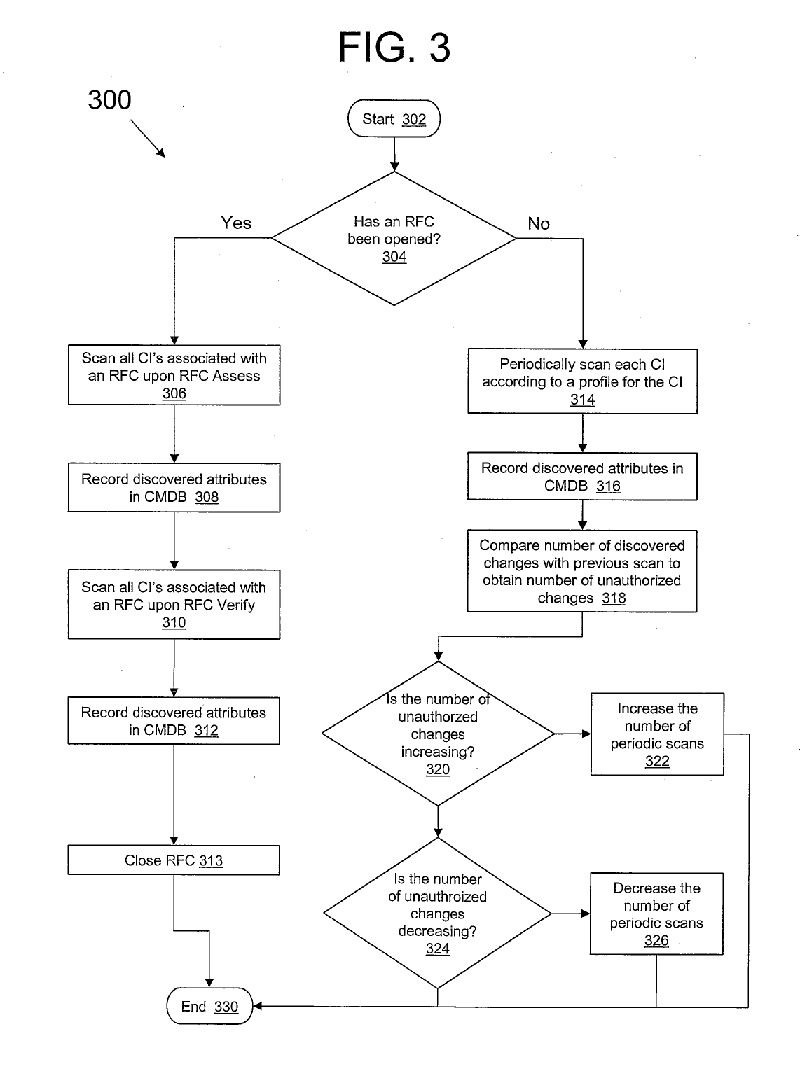

Application programs 144 in the system memory of data processing system 102 (as well as the system memory of software deploying server 150) also include an enhanced service management program 148. Service management program 148 comprises computer-executable code, at least a portion of which implements the method described herein with reference to FIG. 3. In one embodiment, data processing system 102 is able to download service management program 148 from software deploying server 150.

The hardware elements depicted in data processing system 102 are not intended to be exhaustive, but rather are representative to highlight essential components required by the present invention. For instance, data processing system 102 may include alternate memory storage devices such as magnetic cassettes, Digital Versatile Disks (DVDs), Bernoulli cartridges, and the like. These and other variations are intended to be within the spirit and scope of the present invention.

Note further that, in one embodiment of the present invention, software deploying server 150 performs all of the functions associated with the present invention (including execution of service management program 148), thus freeing data processing system 102 from having to use its own internal computing resources to execute service management program 148.

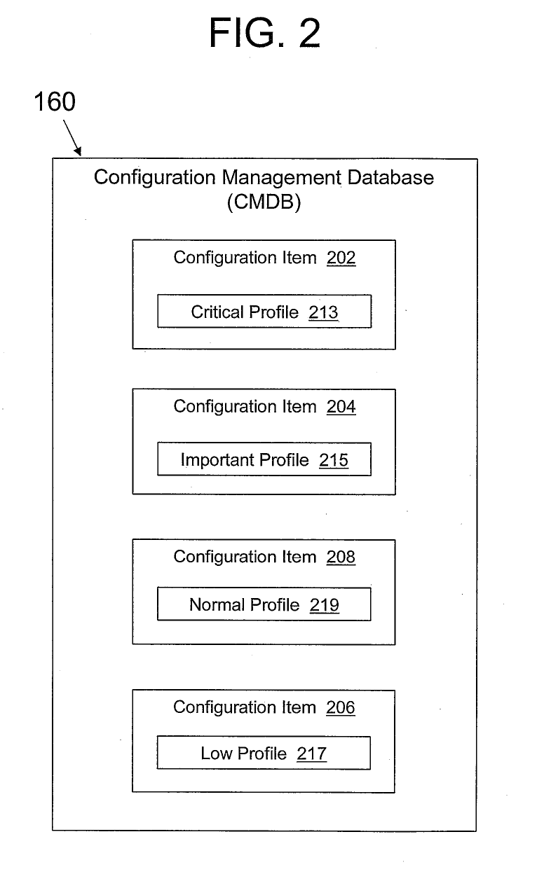

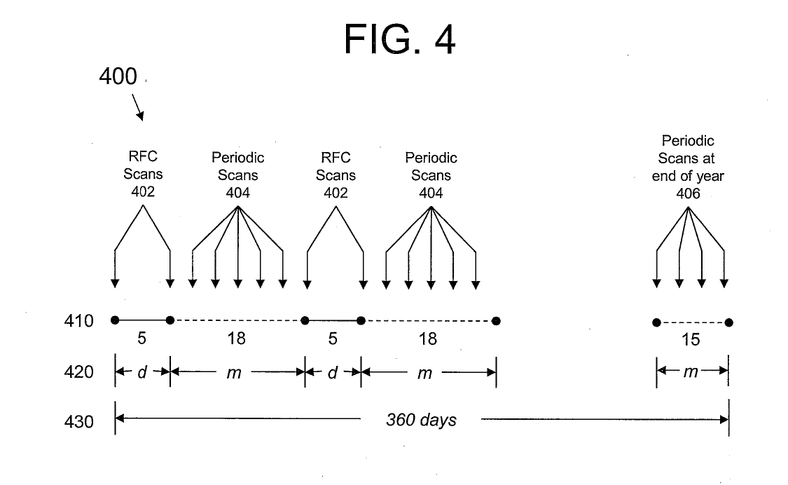

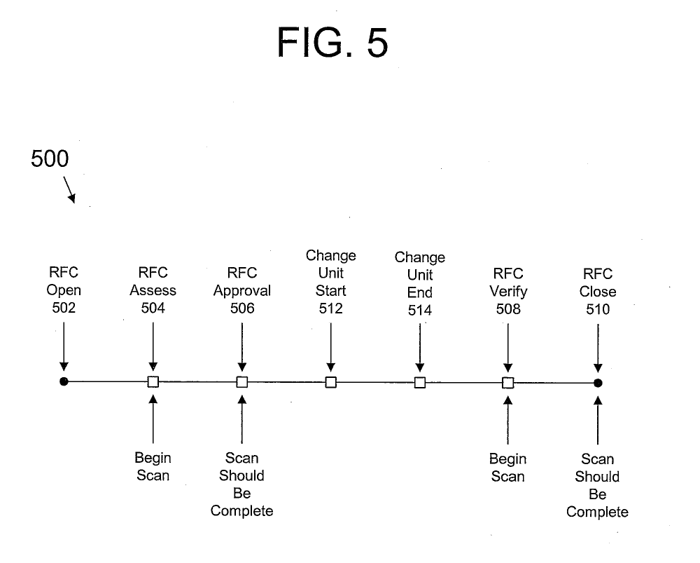

With reference now to FIG. 2, a diagram depicting configuration management database (CMDB) 160 is shown. CMDB 160 is a repository of information related to all the components of an information system. Each component of an information system is known as a configuration item (CI), shown in FIG. 2 as CIs 202-208. A CI is an IT asset or a combination of IT assets that may depend on and have relationships with other IT processes. Configuration items and details about the important attributes and relationships between CIs (e.g., process artifacts such as changes and incidents) are recorded in CMDB 160. While some of these attributes are recorded during the course of standard IT process operations, much of it is actually detected directly from the individual CIs through a “discovery” operation. The present invention provides an improved method for performing such discovery operations. Each CI is assigned a profile 213-217 which determines, among other things, the period between discovery scans. These profiles are discussed in greater detail with respect to FIG. 4.

Service management program 148 utilizes an “amortized” approach to scheduling discovery scans of configuration items. The “amortized” approach spreads out the scans based on informational need and change process occurrences, instead of scanning solely based on a constant, periodic time intervals. Service management program 148 initiates discovery scans on-demand, at the beginning and end of processing a request for change (RFC). A request for change (RFC) is a document containing a call for an adjustment of one or more configuration items (CI). An RFC is of great importance in the change management process.

The beginning of the RFC is defined as the point of approval of the RFC, since that is the point in time when a change impact assessment should be completed. Scanning the list of Cl's associated with the RFC provides an immediately accurate picture of the actual configuration. The end of the RFC is naturally defined as the point of closure of the RFC, since this is only done when all the individual change units have been completed. A scan at this point will provide the ability to validate aspects of the completed change units. For example, deployment of new software to a server should have added a relationship in the CMDB, but not modified the CPU model.

A timeline 500 depicting the events in processing an RFC is shown in FIG. 5. First, a new RFC is opened (RFC Open 502) and a change impact assessment is performed (RFC Assess 504). Upon completion of RFC Assess 504, a discovery scan of all CIs associated with the RFC is performed. This discovery scan should be complete by the point of approval of the RFC (RFC Approval 506). Upon approval of the RFC, processing of the change units begins (Change Unit Start 512). Once the processing of the change unit is complete (Change Unit End 514), verification of the completed change units is performed (RFC Verify 508). A second discovery scan is performed on all of the CIs associated with the RFC upon RFC Verify 508. This second discovery scan discovers change history items resulting from the completed change units. The change history items are used to validate completion of the RFC. After the scan is complete, the RFC is closed (RFC close 510).

Ideally, scans in response to RFCs would be the only scans necessary to keep CMDB 160 up-to-date. The scans made in response to an RFC establish “snapshots” of the system within CMDB 160 at the boundaries of authorized changes (e.g., changes authorized by an approved RFC). However, depending on the characteristics of each configuration item, it may be necessary to “fill the gaps” between RFCs with periodic scans during the intervening time period between RFCs. The sole purpose of these periodic scans is to look for unauthorized changes. Any difference in CMDB 160 found during these scans is unauthorized.

Not every configuration item carries the same importance for finding these unauthorized changes. As a result, configuration items are categorized into different discovery profiles 213-219, which will further spread the distribution of these scans. Critical systems (e.g., such as production servers) might be periodically scanned more often between RFCs, to check for unauthorized changes and keep CMDB 160 more up-to-date. On the other hand, lower priority systems (e.g., private development servers) might be scanned once every 30 days between RFCs, or not at all.

In an alternative embodiment, service management program 148 measures the number of unauthorized changes over a baseline period, then reduces the frequency of periodic scans once there is a high degree of confidence that unauthorized changes are not occurring. This becomes a prime candidate for autonomic capabilities in the discovery scheduling.

With reference now to FIG. 3, a flowchart of an exemplary method for providing an enhanced service management program is shown. Flowchart 300 starts at initiator block 302 and proceeds to decision 304, where service management program 148 determines whether an RFC has been opened. If an RFC has been opened, service management program 148 initiates a scan of all configuration items associated with the RFC upon assessment of the RFC (step 306). An overlapping group of RFCs is treated as a singleton, and should be coordinated as much as possible. In step 308, the discovered configuration item attributes are recorded in CMDB 160. At this point, the processing of change units authorized by the RFC takes place. Once the changes are complete, service management program 148 verifies the change units with a second scan. Upon RFC Verify, all configuration items associated with the RFC are again scanned (step 310), and the discovered change history items are recorded in CMDB 160 (step 312). The scan in step 312 effectively takes a snapshot of the system following the changes authorized by the RFC. The RFC is then closed (step 313) and the process ends at terminator block 330.

Returning to decision 304, if an RFC has not been opened, service management program 148 scans configuration items periodically (step 314). The periodic scans are initiated for each configuration item at varying time intervals according to a profile associated with each configuration item. Configuration item attributes discovered by the periodic scans of step 314 are recorded in CMDB 160 (step 316). Configuration item changes discovered by the periodic scans of step 314 are unauthorized changes, since these changes did not occur as a result of an authorized RFC. Service management program 148 compares the number of discovered changes with the number of discovered changes from the previous periodic scan to obtain the number of unauthorized changes (step 318). If the number of unauthorized changes between RFCs is increasing (step 320), service management program 148 increases the number of periodic scans between RFCs (step 322). If the number of unauthorized changes between RFCs is decreasing (step 324), service management program 148 decreases the number of periodic scans between RFCs (step 326). The process ends at terminator block 330.

With reference now to FIG. 4, a timeline 400 is shown depicting an example of “on-demand” scheduling of discovery scans in accordance with one or more embodiments of the present invention. Lines 410-430 correspond to days in a work year of an information system. Configuration items are categorized into discovery profiles according to how often the configuration items need to be scanned. For example, configuration item 202 (e.g., a production server) is assigned critical discovery profile 213. As a result, configuration item 202 is scanned once every 3 days. Configuration item 204 is assigned important discovery profile 215 and is scanned once every 7.5 days. Configuration item 206 is assigned low discovery profile 217 (e.g., private development servers) and is scanned once every 30 days. Three hierarchical discovery profiles are shown in FIG. 2, but there can be more discovery profiles depending upon the level of granularity that is desired for periodic discovery scanning. Also, each resource type can have its own mix of these discovery profiles. For example, only 10% of the server-class machines are considered “critical”, a majority at 40% are “important”, and so on. These percentages can be adjusted as necessary; However, shifting resources toward critical will actually affect both standard discovery and change-based discovery.

Once a set of configuration items and their associated profiles have been defined, a distribution of RFCs is established based upon the average number of RFCs per year for CIs in a profile and the average duration of completing an RFC for that profile. For example, let the work year comprise 360 days, as shown in line 430. For configuration items of a particular discovery profile, 16 RFCs are processed each year with an average duration of 5 days. The duration of RFCs (“RFC duration”) is shown as a solid line on line 410 indicated by interval “d” on line 420. An RFC duration of 5 days over 16 annual RFCs means that 80 days out of the year these configuration items are changed under the authority of an RFC. In the remaining 280 days the configuration items should not undergo an authorized change.

RFCs for the work year are distributed so that they occur at evenly spaced intervals throughout the work year. Every 23 days, a new RFC is approved. Scans performed during an RFC are indicated on timeline 400 as RFC scans 402. A scan of all CIs associated with the RFC is performed upon approval of the RFC. The RFC takes 5 days to complete. On the fifth day, the RFC is closed and another scan of all CIs associated with the RFC is performed. The intervening 18 days between the closing of one RFC and the approval of the next RFC, is the mean time to change (“MTTC”). MTTC periods are indicated by dashed lines on line 410 and indicated by interval “m” on line 420. There should be no changes to configuration items during an MTTC period. Periodic scans 404 of CIs are scheduled according to discovery profile during each MTTC period to detect any unauthorized changes. In the example shown in FIG. 4, periodic scans are performed every 3 days during the MTTC period. The number of scans performed during the MTTC can be increased for more critical configuration items and decreased for less critical configuration items by changing the discovery profile of the configuration item. At the end of the work year, the MTTC interval is truncated due to the length of the work year. The MTTC period is only 15 days long and 4 periodic scans 406 are performed, one every 3 days.

While timeline 400 depicts scheduling for “on-demand” discovery scanning for a single RFC, an alternative embodiment of the present invention includes batch processing of discovery scans for multiple RFCs. In this embodiment, multiple RFCs scheduled for a particular day are processed in a single “batch” that day. The input to a batch is a query of all the RFCs with state changes for that day and their associated CIs. Discovery scans are initiated for all affected CIs upon assessment and verification of the RFCs being processed that day.

The change-based discovery of enhanced service management program 148 is an important technique for insuring the accuracy of process measurements in CMDB 160. In addition, enhanced service management program 148 enables more accurate change impact assessment reports, since a discovery snapshot is taken at change approval time. Enhanced service management program 148 provides the ability to validate completed changes, since a second discovery snapshot is taken at change close time, and the ability to accurately identify unauthorized changes, since all authorized changes are bounded by the snapshots. In many scenarios, the number of total scans is reduced, since the scans are spread out based on the rate of change and requirement for being current, resulting in overall service management performance improvements.

While the present invention has been particularly shown and described with reference to an illustrative embodiment, it will be understood by those skilled in the art that various changes in form and detail may be made therein without departing from the spirit and scope of the invention. Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

The flowchart and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A method in a data processing system comprising:
scanning a configuration item associated with a first request for change at the time of assessment of the first request for change to determine a first configuration of said configuration item;
recording said first configuration of said configuration item in a configuration management database;
scanning said configuration item associated with said first request for change at the time of verification of the first request for change to determine a second configuration of said configuration item;
recording said second configuration of said configuration item in said configuration management database;
periodically scanning said configuration item to determine a third configuration of said configuration item,
wherein said periodically scanning is performed between the close of said first request for change and an open of a second request for change to detect unauthorized changes to said configuration item;
wherein a schedule for said periodically scanning is determined based upon a discovery profile for said configuration item; and
recording said third configuration of said configuration items in said configuration management database.

2. The method of claim 1, farther comprising:
servicing more than one request for change at random intervals over a predefined length of time interspaced between said periodically scanning.

3. The method of claim 1,
wherein said periodically scanning occurs more frequently for configuration items having discovery profiles of a higher priority; and
wherein said periodically scanning occurs less frequently for configuration items having discovery profiles of a lower priority.

4. The method of claim 1, further comprising:
detecting a number of unauthorized changes to said configuration item;
in response to an increase in the number of unauthorized changes to the configuration item, increasing a frequency for said periodically scanning the configuration item; and
in response to a decrease in the number of unauthorized changes to the configuration items, decreasing the frequency for said periodically scanning the configuration item.

5. The method of claim 1, wherein the method is applied as a batch process to a plurality of requests for change.

6. A system comprising:
means for scanning a configuration item associated with a first request for change at the time of assessment of the first request for change to determine a first configuration of said configuration item;
means for recording said first configuration of said configuration item in a configuration management database;
means for scanning said configuration item associated with said first request for change at the time of verification of the first request for change to determine a second configuration of said configuration item;
means for recording said second configuration of said configuration item in said configuration management database;
means for periodically scanning said configuration item to determine a third configuration of said configuration item,
wherein said periodically scanning is performed between the close of said first request for change and an open of a second request for change to detect unauthorized changes to said configuration item;
wherein a schedule for said periodically scanning is determined based upon a discovery profile for said configuration item; and
means for recording said third configuration of said configuration items in said configuration management database.

7. The system of claim 6, further comprising:
means for servicing more than one request for change at evenly spaced intervals over a predefined length of time interspaced between said periodically scanning.

8. The system of claim 6,
wherein said periodically scanning occurs more frequently for configuration items having discovery profiles of a higher priority; and
wherein said periodically scanning occurs less frequently for configuration items having discovery profiles of a lower priority.

9. The system of claim 6, farther comprising:
means for detecting a number of unauthorized changes to said configuration item;
means for in response to an increase in the number of unauthorized changes to the configuration item, increasing a frequency for said periodically scanning the configuration item; and
means for in response to a decrease in the number of unauthorized changes to the configuration items, decreasing the frequency for said periodically scanning the configuration item.

10. The system of claim 6, wherein the system processes a plurality of requests for change as a batch process.

11. A computer-readable medium encoded with a computer program product that, when executed, performs the steps of:
scanning a configuration item associated with a first request for change at the time of assessment of the first request for change to determine a first configuration of said configuration item;
recording said first configuration of said configuration item in a configuration management database;
scanning said configuration item associated with said first request for change at the time of verification of the first request for change to determine a second configuration of said configuration item;
recording said second configuration of said configuration item in said configuration management database;
periodically scanning said configuration item to determine a third configuration of said configuration item,
wherein said periodically scanning is performed between the close of said first request for change and an open of a second request for change to detect unauthorized changes to said configuration item;
wherein a schedule for said periodically scanning is determined based upon a discovery profile for said configuration item; and
recording said third configuration of said configuration items in said configuration management database.

12. The computer-readable medium of claim 11, further comprising:
servicing more than one request for change at evenly spaced intervals over a predefined length of time interspaced between said periodically scanning.

13. The computer-readable medium of claim 11,
wherein said periodically scanning occurs more frequently for configuration items having discovery profiles of a higher priority; and
wherein said periodically scanning occurs less frequently for configuration items having discovery profiles of a lower priority.

14. The computer-readable medium of claim 11, further comprising:
detecting a number of unauthorized changes to said configuration item;
in response to an increase in the number of unauthorized changes to the configuration item, increasing a frequency for said periodically scanning the configuration item; and
in response to a decrease in the number of unauthorized changes to the configuration items, decreasing the frequency for said periodically scanning the configuration item.

15. The computer-readable medium of claim 11, wherein the computer program product, when executed, processes a plurality of requests for change as a batch process.
